(19) United States
(12) Patent Application Publication
(10) Pub. No.: US 2024/0255931 A1
(43) Pub. Date: Aug. 1, 2024

(54) AN APPARATUS, SYSTEM AND METHOD FOR FUNCTIONAL TEST FAILURE PREDICTION

(71) Applicant: JABIL INC., St. Petersburg, FL (US)

(72) Inventor: Ragai Khalil, St. Petersburg, FL (US)

(21) Appl. No.: 18/560,822

(22) PCT Filed: May 27, 2022
(86) PCT No.: PCT/US22/31401

§ 371 Date: Nov. 14, 2023

Related U.S. Application Data
(60) Provisional application No. 63/194,519, filed on May 28, 2021.

(51) Int. Cl. G05B 19/418

(52) U.S. Cl. CPC G05B 19/41875; G05B 2219/32368

(57) ABSTRACT

A functional test failure prediction (FTFP) engine. The engine includes: a plurality of inputs, capable of receiving at least: a product design; a manufacturing design for the product design; a plurality of specified functional parameters for the product design; bills of materials for the product design; and prior outcome feedback. Also included are: at least one algorithm for virtually applying a plurality of product-specific tests to the product design and the manufacturing design; a comparator capable of comparing an outcome of the algorithm to the specific functional parameters; at least one learning module capable of learning from at least the actual application of the product-specific tests; a feedback loop to provide at least the comparator outcome and the learning of the learning module back to the plurality of inputs as the prior outcome feedback; and a graphical user interface output capable of providing at least the outcome of the comparator.

### CROSS-REFERENCE TO RELATED APPLICATION

This application claims the benefit of priority to U.S. Provisional Application No. 63/194,519, filed May 28, 2021, entitled APPARATUS, SYSTEM AND METHOD FOR FUNCTIONAL TEST FAILURE PREDICTION, the entirety of which is incorporated herein by reference as if set forth in its entirety.

### BACKGROUND

### Field of the Disclosure

The disclosure relates to manufacturing and, more particularly, to an apparatus, system and method for functional test failure prediction.

### Description of the Background

Functional Testing (FT) is one of the most critical test gates in a manufacturing and production environment. More particularly, FT validates: the performance of a given product based on its test specifications, i.e., the parametric performance of the product as compared to its acceptable functional parameters; and the manufacturing process used to build and fabricate the product to meet its specifications, i.e., to not merely be functional, but to be parametrically functional.

Typically, FT detects failures caused by any of several factors, including product design, hardware and software problems, component failures, and defects induced by the manufacturing processes. The latter defects might be, for example, an integrated circuit chip that under-performs because it is subjected to overheating during manufacture. Products that fail FT require extensive debug and troubleshooting, such in either or both of the product design and its manufacturing process, which negatively impacts production throughput, manufacturing cycle time, and product cost, among many other drawbacks.

Accordingly, the need exists for precursor “testing” to enable the estimation of parametric failure modes at functional testing before the product is manufactured, or even before the design of the product or its manufacturing methodology is complete.

### SUMMARY OF THE DISCLOSURE

The disclosed embodiments are and include a functional test failure prediction (FTFP) engine embodied in non-transitory computing code for execution by at least one processor. The engine includes: a plurality of inputs, capable of receiving at least: a product design; a manufacturing design for the product design; a plurality of specified functional parameters for the product design; bills of materials for the product design; and prior outcome feedback.

Also included are: at least one algorithm for virtually applying a plurality of product-specific tests to the product design and the manufacturing design; a comparator capable of comparing an outcome of the algorithm to the specific functional parameters to assess whether, were the product-specific tests actually applied, the product design would meet or exceed the specified functional parameters; at least one learning module capable of learning from at least the actual application of the product-specific tests, and eventual performance of a product resultant from the product design and the manufacturing design; a feedback loop to provide at least the comparator outcome and the learning of the learning module back to the plurality of inputs as the prior outcome feedback; and a graphical user interface output capable of providing at least the outcome of the comparator to a user.

### BRIEF DESCRIPTION OF THE DRAWINGS

The disclosed non-limiting embodiments are discussed in relation to the drawings appended hereto and forming part hereof, wherein like numerals indicate like elements, and in which:

FIG. 1 is a block diagram illustrating a FTFP engine;

FIG. 2 is a flow diagram illustrating the operations of a FTFP engine; and

FIG. 3 is a flow diagram illustrating the movement of data through a system including a FTFP engine.

### DETAILED DESCRIPTION

The figures and descriptions provided herein may have been simplified to illustrate aspects that are relevant for a clear understanding of the herein described apparatuses, systems, and methods, while eliminating, for the purpose of clarity, other aspects that may be found in typical similar devices, systems, and methods. Those of ordinary skill may thus recognize that other elements and/or operations may be desirable and/or necessary to implement the devices, systems, and methods described herein. But because such elements and operations are known in the art, and because they do not facilitate a better understanding of the present disclosure, for the sake of brevity a discussion of such elements and operations may not be provided herein. However, the present disclosure is deemed to nevertheless include all such elements, variations, and modifications to the described aspects that would be known to those of ordinary skill in the art.

Embodiments are provided throughout so that this disclosure is sufficiently thorough and fully conveys the scope of the disclosed embodiments to those who are skilled in the art. Numerous specific details are set forth, such as examples of specific components, devices, and methods, to provide a thorough understanding of embodiments of the present disclosure. Nevertheless, it will be apparent to those skilled in the art that certain specific disclosed details need not be employed, and that embodiments may be embodied in different forms. As such, the embodiments should not be construed to limit the scope of the disclosure. As referenced above, in some embodiments, well-known processes, well-known device structures, and well-known technologies may not be described in detail.

The terminology used herein is for the purpose of describing particular embodiments only and is not intended to be limiting. For example, as used herein, the singular forms “a”, “an” and “the” may be intended to include the plural forms as well, unless the context clearly indicates otherwise. The terms “comprises,” “comprising,” “including,” and “having,” are inclusive and therefore specify the presence of stated features, integers, steps, operations, elements, and/or components, but do not preclude the presence or addition of one or more other features, integers, steps, operations, elements, components, and/or groups thereof. The steps, processes, and operations described herein are not to be construed as necessarily requiring their respective performance in the particular order discussed or illustrated, unless specifically identified as a preferred or required order of performance. It is also to be understood that additional or alternative steps may be employed, in place of or in conjunction with the disclosed aspects.

When an element or layer is referred to as being “on”, “engaged to”, “connected to” or “coupled to” another element or layer, it may be directly on, engaged, connected or coupled to the other element or layer, or intervening elements or layers may be present, unless clearly indicated otherwise. In contrast, when an element is referred to as being “directly on,” “directly engaged to”, “directly connected to” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). Further, as used herein the term “and/or” includes any and all combinations of one or more of the associated listed items.

Yet further, although the terms first, second, third, etc. may be used herein to describe various elements, components, regions, layers and/or sections, these elements, components, regions, layers and/or sections should not be limited by these terms. These terms may be only used to distinguish one element, component, region, layer or section from another element, component, region, layer or section. Terms such as “first,” “second,” and other numerical terms when used herein do not imply a sequence or order unless clearly indicated by the context. Thus, a first element, component, region, layer or section discussed below could be termed a second element, component, region, layer or section without departing from the teachings of the embodiments. Processor-implemented control modules, systems and method may be disclosed herein that may provide access to and transformation of a plurality of types of digital content, including but not limited to video, image, text, audio, metadata, algorithms, identifiers, interactive and document content, and which track, deliver, manipulate, transform, transceive and report the accessed content to control and execute the manufacturing processes discussed herein. Described embodiments of these control modules, systems and methods processed by a processing system are intended to be exemplary and not limiting.

The disclosed Functional Test Failure Prediction (FTFP) engine 100 is comprised of a model/algorithm 102 embodied in software code, suitable for execution from at least one non-transitory computing memory 104 by at least one processor 106. The disclosed FTFP engine 100 predicts parametric, i.e., functional but outside of acceptable parameters, failure during FT. The prediction is based solely on product-specific design information, and thus is provided by the engine prior to building a product in manufacturing. As such, the embodiments transform and transceive received data, in the form of input product and manufacturing design information 120, into output 122 of a probabilistic analysis of the likelihood of feature or overall design failure or underperformance prior to testing of the design. That is, the embodiments predict design faults, flaws and errors before production, which cause parametric failures at FT during the manufacturing and production phases.

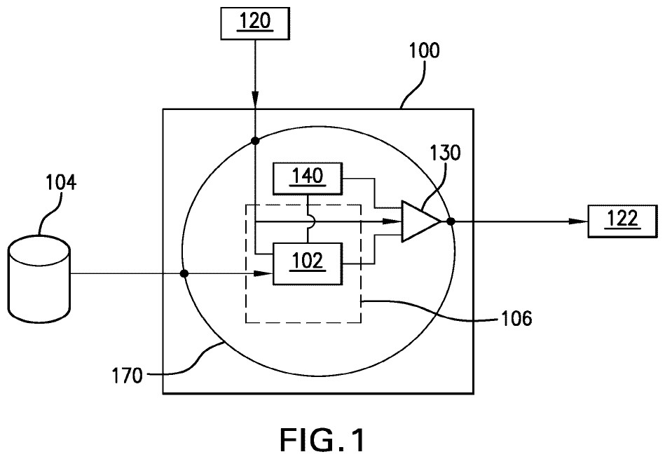

The engine 100 resides in a processing system with access to a computerized version of both the product and its manufacturing methodology. As illustrated in FIG. 1, the engine applies the disclosed algorithm(s) 102 from its resident memory 104 in order to perform FTFP on the input designs. The product and manufacturing methodology designs may be manually provided to the engine, i.e., at the directive of a user, or may be automatically accessible to the engine.

The FTFP engine is applied to the product and manufacturing designs during the design phase, i.e., prior to production of a product. The engine utilizes the received product-specific design details data 120 such as: schematics; bills of materials; product functional specifications and thresholds; and test specifications. This and other information may be provided to one or more inputs of the engine.

By way of example, product design specifications and schematics may typically be generated by customers' design engineering teams using automation tools, such as ODB++. This information may be manually uploaded, or may be automatically extracted and downloaded, via the inputs of the FTFP engine.

The engine includes a comparator 130. Parametric measurements that can potentially become failure modes at FT are derived from product-specific test specifications, such as current, voltage, power, error rate, and so on. The comparator 130 compares these derived parametric measurements to the conditions to which the product elements will be subjected before, during, and after (such as during transport) testing or manufacturing, pursuant to the present manufacturing design. The comparator 130 also compares the conditions of some product elements to others, in order to find potential “weak links” in the product.

As shown, the engine further includes an artificial intelligence (AI) learning module 140. The AI module may track designs which are input, the schematics, materials, etc., thereof, the specifications to be met, the parametric performance predicted by the engine, any received design changes, and ultimate outcomes when FT was applied. Therefrom, the AI module may “learn” to adjust the predictions of the engine as assessed by the comparator. That is, the AI module learns when it is right, partly right, or wrong, and to what percent its assessments are valid, as to components of a product, conditions, manufacture methods, etc., based, in part, on the ultimate FT outcome.

Predicting parametric failure modes at FT using the FTFP engine in the product design phase translates directly to designing effective and efficient debug and troubleshooting techniques for the testing phase and in manufacturing. The AI module may, of course, learn design solutions, which may be conveyed to designers during the design phase. Thus, the engine may enable: optimization of capital test equipment, and associated costs, required for debug; reduction of debug technicians, and associated costs, needed to perform troubleshooting; minimization of debug-rework-retest cycle times and associated costs; accelerating production throughput to meet customers' commitments; reduction of overall product cost and increased revenues; and enabling “factory of the future” corporate goals.

Simply put, the engine and its components provide a closed feedback loop 170 for optimized product and manufacturing methodology design. It enables designers to be proactive rather than reactive. The FTFP engine is thus applied during the design phase, once the required inputs are made available by a customer's design engineering. The FTFP engine runs updates as the designs change. Manufacturing test data may be collected and analyzed, as is FT outcome. These are used to validate the FTFP engine's predicted failures, and to update the engine's algorithms via the AI learning module in order to improve the engine's predictions via this closed feedback loop.

Development of the FTFP engine may engage in its analysis on any number of design elements, and the number of design elements may vary by the design vertical and the intended product technology applications, i.e., a computer hard drive or a photonic component may be subjected to a very different FTFP analysis than is a coffee machine. By way of example, analyzed design elements may include: all design inputs which are product-design specific; analysis of the particular possible parametric failure points at FT, based on the specifications; a unique algorithm for the design and its elements (such as may stem, in part, from the AI module), which may vary by product vertical or manufacturing method, by way of non-limiting example, to assign a probability of failure occurrence for each parameter; data processing on the collected inputs; and a user interface (UI) to display automatically the possible parametric failures with associated failure probabilities. Needless to say, the UI may provide interim computations and/or results in any known format, such as tabulated, bar/line chart, etc.).

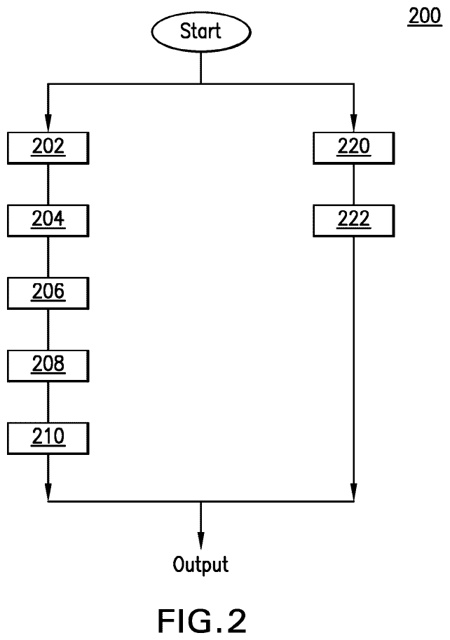

In the exemplary embodiment of the flow of FIG. 2, a parametric failure algorithm may perform in multiple parallel chains. In the illustration, chain 202 may perform anomaly or “weak link” detection. In this chain 202, particular design elements and/or manufacturing steps having atypically high rates of failure are assessed at step 204; manufacturing steps for which conditions violate the acceptable conditions for elements are assessed at step 206; elements having a historic or learned (via the AI learning module) incompatibility with other parts or with certain manufacturing methods (i.e., glue, paint, plasticization, etc.) are assessed at step 208; and inefficient or ineffective manufacturing steps are assessed at 210.

Chain 220 may perform statistical failure prediction. More specifically, step 222 may assess failure probabilities not directly evident from the data. That is, certain parts or manufacturing steps may often cause failure when used in certain combinations, notwithstanding that no conditions or specifications are violated for such parts or steps.

This step 222 may occur using an aggregated variable analysis to predict failures. In such an analysis, statistically significant anomalies upon combinations of aggregated variables may be learned.

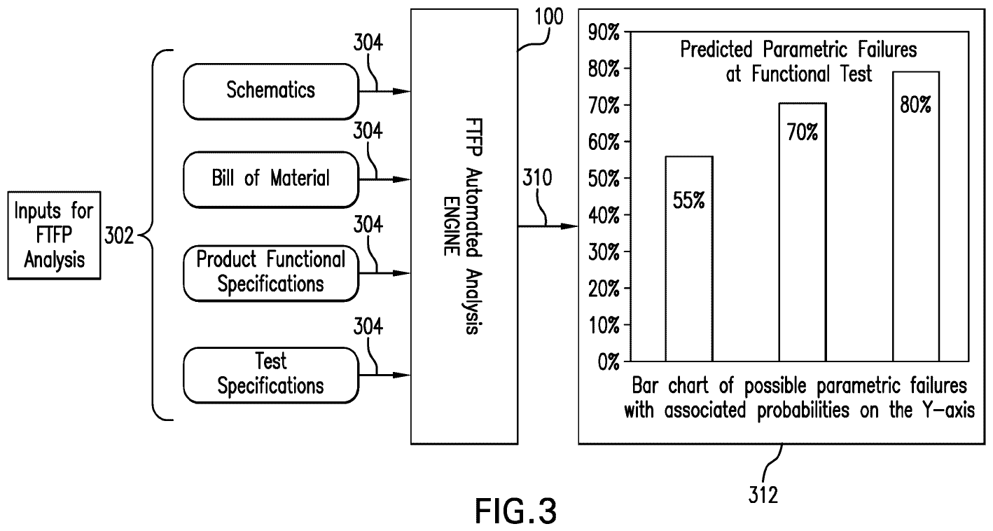

FIG. 3 illustrates a flow of the data into and through the engine of FIGS. 1 and 2. In the illustrated flow, data 302 in the form of at least schematics, bills of materials, functional specifications, and test specifications, are provided as inputs 304 to the engine 100. Of course, the skilled artisan will appreciate that other inputs may be provided, such as: a manufacturing method or multiple optional methods; most critical design features or specifications; historic design data and performance, in the same vertical, other verticals, by part irrespective of application, and so on.

The engine 100 performs its analysis on the input data 302. This analysis may include learned features of the analysis, and is predictive in nature. The predictive output 310 is then provided to designers, such as through a GUI 312. Additional provided may be optional design modifications. These suggested designs or design modifications may each also be subject to a probabilistic failure analysis by the engine, such that design engineers may be enabled to pick the design that is least likely to lead to failures, which is most cost effective, which is least time or resource consuming, and the like.

In short, the failure analysis may present failure modes and a probabilistic analysis. For example, the engine disclosed may estimate that there is a 55% chance that a product design will failure testing, and more particularly that there are 9 prospective failure modes with a failure probability above a predetermined threshold of 5%. This allows for designers to: estimate debug time; estimate debug costs, estimate debug resources; recommend re-design focus prior to production; estimate necessary cost and manpower to address failure modes during eventual manufacture in order to maintain acceptable failure rates; and estimate throughput of a design upon delivery. Simply put, the embodiments indicate likely failures, how those failures are likely to occur, where to focus to address those likely failures, and how long it will take and how much it will cost to address those failures, prior to actual testing. This is highly distinct from the known art, in which most failure modes, and the probabilities related thereto, are only found during testing and after at least limited production.

Accordingly, the embodiments not only improve first pass yield (FPY) of a design even before the prototype phase, but more particularly enable a cost-effective targeted re-design. This is the case because the specific aspects of the product that lead to an unacceptable FPY prior to prototype production are probabilistically noted prior to the prototype phase, as are the costs to address those specific aspects. In the foregoing detailed description, it may be that various features are grouped together in individual embodiments for the purpose of brevity in the disclosure. This method of disclosure is not to be interpreted as reflecting an intention that any subsequently claimed embodiments require more features than are expressly recited.

Further, the descriptions of the disclosure are provided to enable any person skilled in the art to make or use the disclosed embodiments. Various modifications to the disclosure will be readily apparent to those skilled in the art, and the generic principles defined herein may be applied to other variations without departing from the spirit or scope of the disclosure. Thus, the disclosure is not intended to be limited to the examples and designs described herein, but rather is to be accorded the widest scope consistent with the principles and novel features disclosed herein.

What is claimed is:

1. A functional test failure prediction (FTFP) engine embodied in non-transitory computing code for execution by at least one processor, comprising:
a plurality of inputs, capable of receiving at least:
a product design;
a manufacturing design for the product design;
a plurality of specified functional parameters for the product design;
bills of materials for the product design; and
prior outcome feedback;
at least one algorithm for virtually applying a plurality of product-specific tests to the product design and the manufacturing design;
a comparator capable of comparing an outcome of the algorithm to the specific functional parameters to assess whether, were the product-specific tests actually applied, the product design would meet or exceed the specified functional parameters;
at least one learning module capable of learning from at least the actual application of the product-specific tests, and eventual performance of a product resultant from the product design and the manufacturing design;
a feedback loop to provide at least the comparator outcome and the learning of the learning module back to the plurality of inputs as the prior outcome feedback; and
a graphical user interface output capable of providing at least the outcome of the comparator to a user.

2. The engine of claim 1, wherein the product design, the specified functional parameters, and the manufacturing design are manually uploaded to the inputs from a graphical user interface.

3. The engine of claim 1, wherein the product design, the specified functional parameters, and the manufacturing design are automatically uploaded to the inputs.

4. The engine of claim 3, wherein the automatic upload is using ODB++.

5. The engine of claim 1, wherein the product-specific tests include current, voltage, power, and error rate testing.

6. The engine of claim 1, wherein the outcome of the comparator includes weak links in the product design.

7. The engine of claim 1, wherein the learning module comprises an artificial intelligence (AI).

8. The engine of claim 1, wherein the comparator outcome is a probabilistic prediction of compliance with the specified functional parameters.

9. The engine of claim 1, wherein the prior outcome feedback includes historic data.

10. The engine of claim 1, wherein the historic data includes atypically high failure rates for elements on the bills of materials.

11. The engine of claim 1, wherein the bills of materials includes incompatibility as between parts

12. The engine of claim 1, wherein the bills of materials includes incompatibility of parts with the manufacturing design.
